(19) United States
(12) Patent Application Publication
(10) Pub. No.: US 2011/0228191 A1
(43) Pub. Date: Sep. 22, 2011

(54) DISPLAY DEVICE

(75) Inventors: KUN-HUANG HSU, SHULIN CITY (TW); SIH-REN FU, TAIPEI CITY (TW)

(73) Assignee: PEGATRON CORPORATION, TAIPEI CITY (TW)

(21) Appl. No.: 12/638,409

(22) Filed: Dec. 15, 2009

(30) Foreign Application Priority Data
Dec. 16, 2008 (TW) 097149012

(51) Int. Cl. G02F 1/1333

(52) U.S. Cl. 349/58

(57) ABSTRACT

This invention discloses a display device. The display device includes a first panel, a second panel, and an elastic ring. The second panel is disposed over the first panel. The elastic ring includes a first portion and a second portion. An inner side of the first portion has a concave. The second portion extends from the concave of the inner side of the first portion. The elastic ring surrounds and tightly wraps outer edges of the first panel and the second panel with the concave of the inner side, and the second portion is sandwiched between the first panel and the second panel to allow a gap to be formed between the first panel and the second panel.

### CROSS-REFERENCE TO RELATED APPLICATIONS

This Non-provisional application claims priority under 35 U.S.C. §119(a) on Patent Application No(s). 097149012 filed in Taiwan, Republic of China on Dec. 16, 2008, the entire contents of which are hereby incorporated by reference.

### BACKGROUND OF THE INVENTION

1. Field of the Invention

The invention relates to a display device and, more particularly, to a display device having an elastic fixing structure.

2. Description of the Related Art

In recent years, with continuous improvement of the technology related to display devices, various kinds of the display devices (such as liquid crystal display devices) have gradually become main products in the market.

A liquid crystal display device is taken for example. Usually a protective panel (such as a transparent panel, a tempered glass panel and so on) may be disposed on a liquid crystal display panel to prevent the liquid crystal display panel from being damaged directly from external environment. In addition, a touch liquid crystal display device having a touch function especially attracts common consumers' attention in the present market. At that moment, a touch panel is further needed to be disposed on the liquid crystal display panel to achieve the touch function.

That is, when the liquid crystal display device is assembled, the liquid crystal display panel needs to be capable of adhering to the touch panel, the transparent panel, or the tempered glass panel. Conventionally, double-faced adhesive tapes or other adhesive materials are mostly used for adhering.

FIG. 1 is a sectional schematic diagram showing a conventional liquid crystal display device where a liquid crystal display panel and a touch panel adhere to each other with a double-faced adhesive tape. In FIG. 1, a display device 1 includes a liquid crystal display panel 11, a touch panel 12, and a double-faced adhesive tape 13. As shown in FIG. 1, the liquid crystal display panel 11 and the touch panel 12 adhere to each other with the double-faced adhesive tape 13 to achieve a fixing function. FIG. 2 is an exploded diagram showing the liquid crystal display panel 11, the touch panel 12, and the double-faced adhesive tape 13 in FIG. 1.

However, the above conventional method has following disadvantages. After the liquid crystal display panel 11 adheres to the touch panel 12 with the double-faced adhesive tape 13, the liquid crystal display panel 11 is difficult to be separated from the touch panel 12 while the position where the touch panel 12 adheres to the liquid crystal display panel 11 is wrong thus to cause reassembly, or while either the liquid crystal display panel 11 or the touch panel 12 needs to be repaired. Further, the liquid crystal display panel 11 or the touch panel 12 may be damaged by great force in disassembling or assembling.

In addition, in FIG. 3, a conventional liquid crystal display device 2 is shown. Besides a double-faced adhesive tape 23 between a touch panel 22 and a liquid crystal display panel 21, a soft gasket 24 is disposed between a bezel 27 and the touch panel 22 of the liquid crystal display device 2. Thus, the fixing function between the touch panel 22 and the liquid crystal display panel 21 is improved by bezel edges 271 and the soft gasket 24. However, for the above conventional method, a plurality of additional components is needed. Thus, the whole manufacturing cost of the liquid crystal display device is hard to be reduced, and the difficulty in assembling is also high

### BRIEF SUMMARY OF THE INVENTION

This invention provides a display device having an elastic fixing structure to improve the prior art. Via the integrally formed elastic fixing structure (such as a rubber ring), the display device in the invention effectively fixes a liquid crystal display panel and another panel (such as a touch panel) and can be assembled and disassembled easily.

In addition, portions of the elastic fixing structure are sandwiched between the liquid crystal display panel and the other panel to form a gap. Therefore, when the whole liquid crystal display or a single element thereof in the invention needs to be reassembled or repaired, the fixed liquid crystal display panel does not need to be separated from the other panel, thereby avoiding damaging the liquid crystal display panel or the other panel.

In one embodiment of the invention, a display device is provided. The display device includes a first panel, a second panel, and an elastic ring. The second panel is disposed over the first panel. The elastic ring includes a first portion and a second portion. An inner side of the first portion has a concave. The second portion extends from the concave of the inner side of the first portion. The elastic ring surrounds and tightly wraps outer edges of the first panel and the second panel with the concave of the inner side, and the second portion is sandwiched between the first panel and the second panel to allow a gap to be formed between the first panel and the second panel.

In the embodiment, the first panel and the second panel may have a top surface and a bottom surface, respectively. The bottom surface of the second panel may face the top surface of the first panel. A rim of the elastic ring may be shrunk to wrap edges of the top surface of the second panel and may extend to the first panel, and another rim of the elastic ring may be shrunk to wrap edges of the bottom surface of the first panel. The shrunken rim and the other shrunken rim of the elastic ring may form the concave of the inner side of the elastic ring. The second portion of the elastic ring may be sandwiched between edges of the bottom surface of the second panel and edges of the top surface of the first panel.

In a preferred embodiment, the first portion and the second portion of the elastic ring may be integrally formed. The first panel may be a liquid crystal display panel. The second panel may be a touch panel, a glass panel, or an acrylic panel. The elastic ring may be a rubber element and may be formed via injection molding.

Compared with the prior art, the display device in the invention can effectively fix the liquid crystal display panel and another panel via the integrally formed elastic fixing structure (such as a rubber ring) thereof. Further, in the following reassembly of the whole liquid crystal display device or a single element thereof, the problem in the prior art can be avoided, and the liquid crystal display device can also have its original waterproof and dustproof function.

In addition, according to the display device in the invention, some elements for adhering, fixing, or supporting in conventional fixing structures can be omitted. Further, the display device in the invention can be assembled and disassembled easily. In addition, the cost of the material (such as rubber) of the elastic ring is also quite low. Thus, the manufacturing process can be greatly simplified and the manufacturing cost can be reduced.

These and other features, aspects, and advantages of the present invention will become better understood with regard to the following description, appended claims, and accompanying drawings.

### BRIEF DESCRIPTION OF THE DRAWINGS

FIG. 1 is a sectional schematic diagram showing a conventional liquid crystal display device where a liquid crystal display panel and a touch panel adhere to each other with a double-faced adhesive tape;

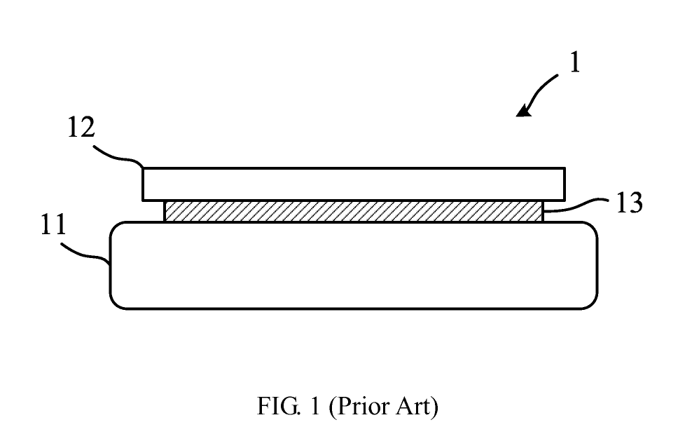

FIG. 2 is an exploded diagram showing the liquid crystal display panel, the touch panel, and the double-faced adhesive tape in FIG. 1;

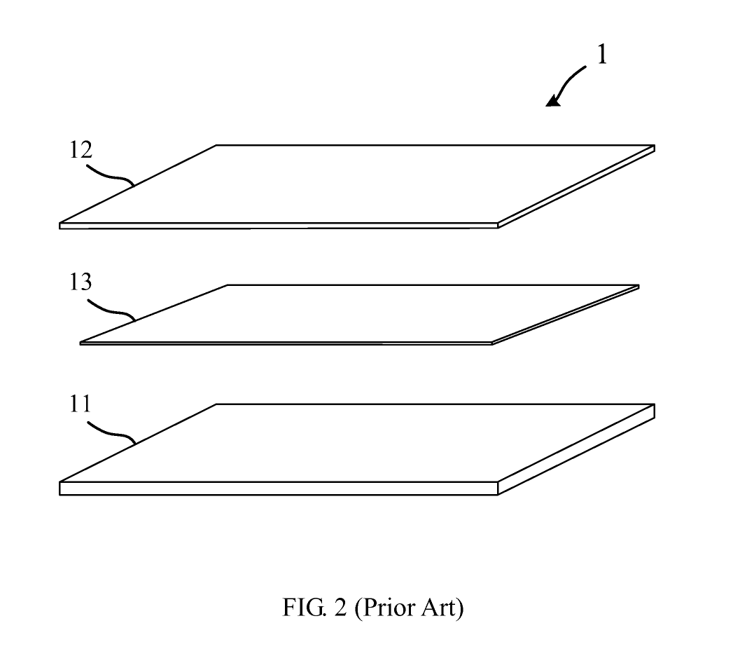

FIG. 3 is a partial sectional schematic diagram showing an inner structure of a conventional liquid crystal display device;

FIG. 4 is a schematic diagram showing a display device where a liquid crystal display panel is fixed to a touch panel with an elastic ring according to an embodiment of the invention;

FIG. 5 is an exploded diagram showing the liquid crystal display panel, the touch panel, and the elastic ring in FIG. 4; and

FIG. 6 is a sectional schematic diagram showing a first portion and a second portion of an elastic ring.

### DETAILED DESCRIPTION OF THE INVENTION

This invention provides a display device having an elastic fixing structure. Via the integrally formed elastic fixing structure (such as a rubber ring), the display device is a liquid crystal display device capable of effectively fixing a liquid crystal display panel and another panel and being easily assembled and disassembled.

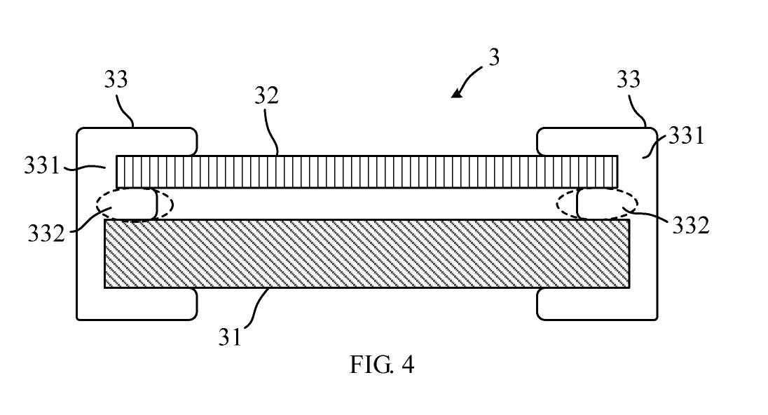

FIG. 4 is a schematic diagram showing a display device where a liquid crystal display panel is fixed to a touch panel with an elastic ring according to an embodiment of the invention. In FIG. 4, a liquid crystal display device 3 includes a liquid crystal display panel 31, a touch panel 32, and an elastic ring 33. The liquid crystal display device 3 further includes other elements such as a backlight module, an optical film and so on. However, to facilitate to describe this embodiment of the invention, functions of the elements are not described and shown in detail.

The touch panel 32 can be replaced by any panel which is to be fixed to the liquid crystal display panel 31, and the panel may be a common transparent panel, a tempered glass panel, an acrylic panel and so on. However, the invention is not limited to the touch panel 32 in the embodiment.

The elastic ring 33 can be made of rubber or other elastic materials and can be formed via injection molding, co-injection molding, or other manufacturing modes.

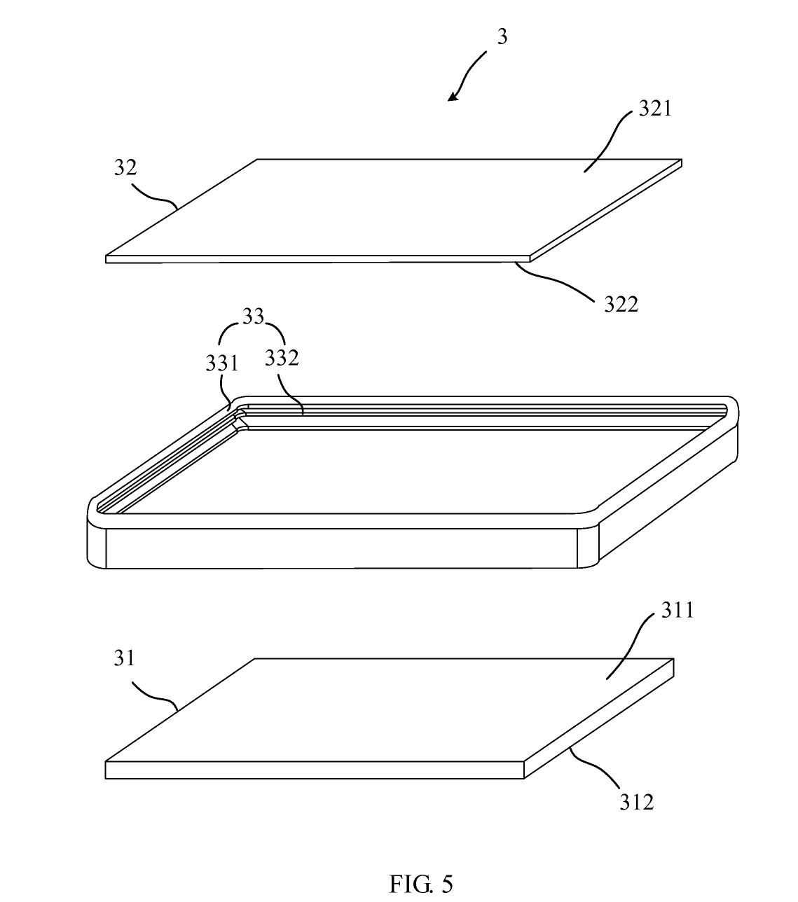

The display device 3 surrounds and tightly wraps outer edges of the liquid crystal display panel 31 and the touch panel 32 with the elastic ring 33 and allows the liquid crystal display panel 31 and the touch panel 32 to maintain a certain gap there between thus to prevent the liquid crystal display panel 31 from touching the touch panel 32 to generate friction and cause abrasion. FIG. 5 is an exploded diagram showing the liquid crystal display panel 31, the touch panel 32, and the elastic ring 33 in FIG. 4.

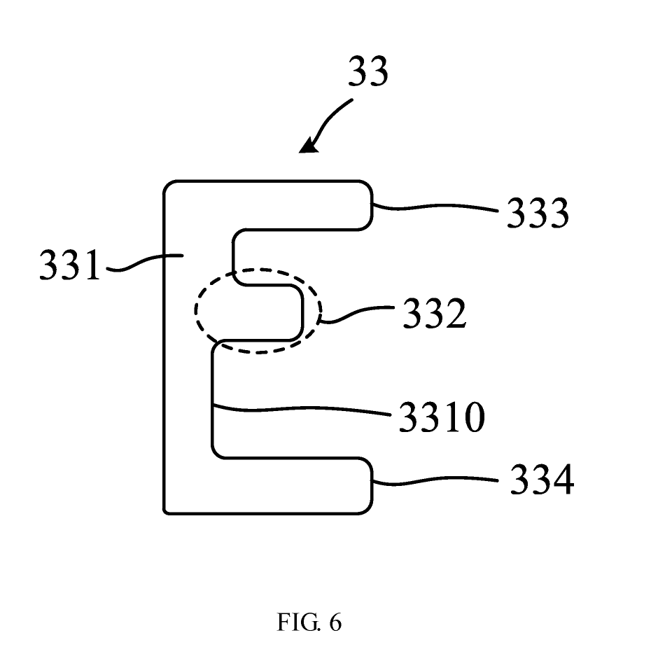

FIG. 6 is a sectional schematic diagram showing a first portion and a second portion of the elastic ring 33. Please refer to FIG. 6. The structure of the elastic ring 33 of the display device 3 is further described in detail.

In FIG. 6, the elastic ring 33 includes a first portion 331 and a second portion 332 (enclosed by a dashed line). An inner side of the first portion 331 has a concave 3310. The second portion 332 extends from the concave 3310 of the first portion 331.

In the embodiment, the liquid crystal display panel 31 has a top surface 311 and a bottom surface 312. The touch panel 32 also has a top surface 321 and a bottom surface 322, and the bottom surface 322 of the touch panel 32 faces the top surface 311 of the liquid crystal display panel 31. A rim 333 of the elastic ring 33 is shrunk to wrap edges of the top surface 321 of the touch panel 32 and extends to the liquid crystal display panel 31, and another rim 334 of the elastic ring 33 wraps edges of the bottom surface 312 of the liquid crystal display panel 31. The concave 3310 of the inner side of the elastic ring 33 is formed by the shrunken rim 333 and the other shrunken rim 334 of the elastic ring 3. Furthermore, the second portion 332 of the elastic ring 33 is sandwiched between edges of the bottom surface 322 of the touch panel 32 and edges of the top surface 311 of the liquid crystal display panel 31.

In fact, the first portion 331 and the second portion 332 of the elastic ring 33 can be integrally formed thus to simplify the manufacturing process of the elastic ring 33 and to achieve a preferred fixing effect. However, the invention is not limited thereto.

Then, different functions of the first portion 331 and the second portion 332 of the elastic ring 33 are described, respectively.

In the embodiment, the main function of the first portion 331 is to surround and tightly wrap the outer edges of the liquid crystal display panel 31 and the touch panel 32 with the concave 3310 of the inner side thereof, thereby fixing the liquid crystal display panel 31 and the touch panel 32.

The second portion 332 extending from the concave 3310 of the first portion 331 is sandwiched between the edges of the bottom surface 322 of the touch panel 32 and the edges of the top surface 311 of the liquid crystal display panel 31, so that the certain gap can be maintained between the liquid crystal display panel 31 and the touch panel 32 thus to prevent the liquid crystal display panel 31 from touching the touch panel 32 to generate friction and cause abrasion.

In addition, the elastic ring 33 is made of elastic materials (such as rubber). That is, the elastic ring 33 has better elasticity. Therefore, when the elastic ring 33 is used to fix the liquid crystal display panel 31 and the touch panel 32, the elastic ring 33 can generate retaining force via interference between the elastic ring 33 and the liquid crystal display panel 31 or the touch panel 32 thus to allow the liquid crystal display panel 31 and the touch panel 32 to fix each other and to retain stable relative positions. The retaining force is exerted inwardly by the elastic ring 33 to the liquid crystal display panel 31 and the touch panel 32 surrounded and tightly wrapped by the elastic ring 33.

To sum up, compared with the prior art, the fixing mode of the elastic ring 33 of the display device 3 in the embodiment of the invention has following functions and advantages.

First, compared with a conventional adhering mode with a double-faced adhesive tape, the elastic ring 33 can be assembled and disassembled more easily. Therefore, when the fixed touch panel 32 and the liquid crystal display panel 31 need to be fixed again, or when the whole the display device 3 or a single element thereof needs to be reassembled or repaired, the display device 3 in the embodiment of the invention can be assembled or disassembled easily. Compared with the conventional adhering mode with the double-faced adhesive tape, the mode with the elastic ring 33 is time-saving and power-saving, and the liquid crystal display panel 31 or the touch panel 32 can be prevented from being damaged.

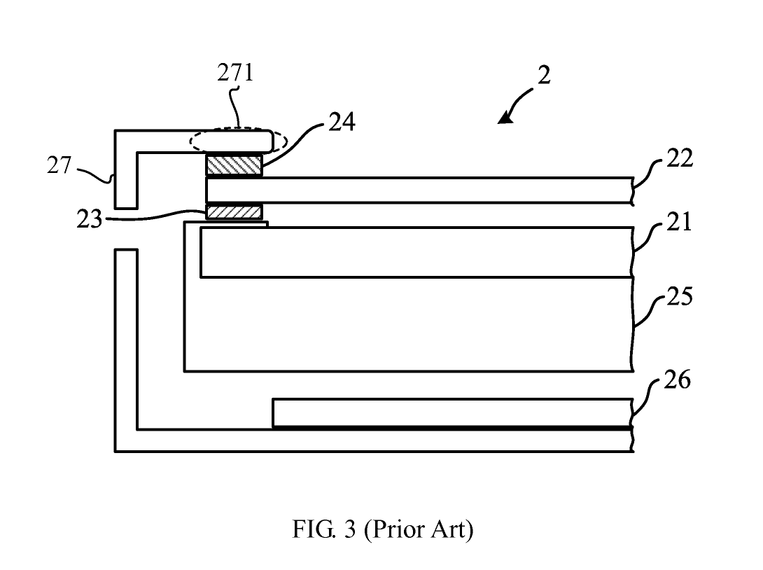

Second, compared with the conventional fixing structure, according to the display device 3 in the embodiment of the invention, since some adhering, fixing, or supporting elements (such as a soft gasket 24 disposed between bezel edges 271 of a casing 27 and a touch panel 22 of a conventional liquid crystal display device 2 or an adhesive tape 23 between the touch panel 22 and a liquid crystal display panel 21 in FIG. 3) can be omitted, and the cost of the material (such as rubber) of the elastic ring 33 is quite low, the manufacturing process of the display device can be greatly simplified and the manufacturing cost can be reduced. Furthermore, the original waterproof and dustproof function is not affected by the use of the elastic fixing mode in the embodiment of the invention and can still be maintained by the display device 3. Thus, after the touch panel 32 and the liquid crystal display panel 31 are assembled in a dust free room, they can be further assembled with a casing of the display device 3 at outside of the dust free MOM.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A display device comprising:
a first panel;
a second panel disposed over the first panel; and
an elastic ring including:
a first portion, an inner side of the first portion having a concave; and
a second portion extending from the concave of the first portion;
wherein the elastic ring surrounds and tightly wraps the outer edges of the first panel and the second panel with the concave of the inner side, and the second portion is sandwiched between the first panel and the second panel to allow a gap to be formed between the first panel and the second panel.

2. The display device according to claim 1, wherein the first portion and the second portion of the elastic ring are integrally formed.

3. The display device according to claim 1, wherein the first panel is a liquid crystal display panel.

4. The display device according to claim 1, wherein the second panel is a touch panel, a glass panel, or an acrylic panel.

5. The display device according to claim 1, wherein the elastic ring is a rubber element.

6. The display device according to claim 1, wherein the elastic ring is formed via injection molding.

7. The display device according to claim 1, wherein the first panel and the second panel have a top surface and a bottom surface, respectively, and the bottom surface of the second panel faces the top surface of the first panel.

8. The display device according to claim 7, wherein a rim of the elastic ring is shrunk to wrap the edges of the top surface of the second panel and extends to the first panel, and another rim of the elastic ring is shrunk to wrap the edges of the bottom surface of the first panel.

9. The display device according to claim 8, wherein the shrunken rim and the other shrunken rim of the elastic ring form the concave of the inner side of the elastic ring.

10. The display device according to claim 7, wherein the second portion of the elastic ring is sandwiched between the edges of the bottom surface of the second panel and the edges of the top surface of the first panel.
